(19) United States
(12) Patent Application Publication
(10) Pub. No.: US 2026/0241530 A1
(43) Pub. Date: Aug. 20, 2026

(54) A MULTIPURPOSE TOOL

(71) Applicant: SKYLOS ECOLOGY PTY LTD, Beaufort, Victoria (AU)

(72) Inventor: Fiona JACKSON, Beaufort (AU)

(73) Assignee: SKYLOS ECOLOGY PTY LTD, Beaufort, Victoria (AU)

(21) Appl. No.: 19/162,210

(22) PCT Filed: Mar. 7, 2024
(86) PCT No.: PCT/AU2024/050191

§ 371 Date: Sep. 4, 2025

(30) Foreign Application Priority Data
Mar. 7, 2023 (AU) 2023900612
Jan. 11, 2024 (AU) 2024900075

(51) Int. Cl. B25F 1/00; A01K 13/00; B25F 1/04; B26B 11/00; B26B 13/22

(52) U.S. Cl. CPC B25F 1/003; A01K 13/00; B25F 1/04; B26B 11/001; B26B 13/22

(57) ABSTRACT

A multipurpose tool configured for use with animals including: a first and second handle, the first handle including a first axle upon which a first subset of tool members is rotatably mounted; the second handle including: a second axle upon which a portion of a second subset of tool members are rotatably mounted; and a third axle upon which another portion of the second subset of tool members are rotatably mounted; a pair of arms, each arm of the pair of arms is connected to the first handle and the second handle, via the first axle and the second axle, respectively, where the first and second handles rotate relative to the respective arms; a fourth axle to which the pair of arms are rotatably mounted; and each arm includes a blade removably mounted to a portion of the arm proximal the fourth axle forming a nail cutting station.

### FIELD OF THE INVENTION

The present invention relates to a multipurpose tool, and in particular to a multipurpose tool for use with animals.

The invention has been developed primarily for use with animals and will be described hereinafter with reference to this application. However, it will be appreciated that the invention is not limited to this particular field of use.

### BACKGROUND OF THE INVENTION

Tools are popular for their versatility and compactness. A multipurpose tool includes several tool members carried by a common frame. A multipurpose tool may include different combinations of tools depending upon its intended application. For example, a multitool intended to be used in a variety of situations is likely to include tool members such as pliers, a wire cutter, one or more knife blades and perhaps a bit driver. Other multitools are designed for specific applications. For example, a multitool designed for bicycles will have tool members specifically for bikes such as different hex bits/Allen keys, a chain rivet extractor, a spoke and/or open wrench and perhaps tyre levers.

There have been some attempts made to provide a basic multipurpose tool for domestic animals such as dogs with a focus on nail clipping. Such devices generally provide a nail clipping component alone or with other elements such as a comb. A problem with this type of tool is that once the cutting edge of the nail clipping element is blunt, the entire tool needs to be replaced.

Other such devices do not assist in training an animal for example general obedience learning, and in some instances scent detection training, nor do they assist outdoor based activities with dogs and other domestic animals, for example when walking multiple dogs or tethering a dog while visiting public facilities such as shops and toileting facilities and the like where dogs are usually prohibited from entering.

To improve convenience for animal trainers and/or animal owners, it would be desirable to provide a multitool that includes a specific combination of tool members, thereby reducing the number of separate tools that need to be carried in the field. It would also be desirable to provide a single multipurpose tool that may be used in animal training.

The present invention seeks to provide a multipurpose tool, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to an aspect of the invention, there is provided a multipurpose tool configured for use with animals, the multipurpose tool including: a first handle and a second handle, the first handle and the second handle each configured for relative movement between a closed position and an open position; a nail clipper configured for cutting an animal nail; and a pair of jaws integrally formed with the nail clipper; the pair of jaws configured for grasping an object.

The invention also provides a multipurpose tool configured for use with animals, the multipurpose tool including: a first handle and a second handle, the first handle and the second handle conjoined at a mutual axle and adapted to move about the mutual axle between a closed position and an actuating or open position; a pair of arms connected to the first and second handle and rotatably mounted to the mutual axle wherein the first and second handle are adapted to pivot relative to the arms; a removable nail clipper on the arms configured for cutting an animal nail; and a pair of jaws integrally formed with the nail clipper; wherein the handles are configured to receive the pair of jaws in a closed condition, and rotating the handles relative to the arms to the actuating position allows closing of the jaws for grasping an object.

The jaws provide a means in the multipurpose tool for grabbing an object which makes it easier for training a scent dog and in particular making it easier to place scent targets in scent detection training without contamination. The nail clipper can be removed and replaced.

The first and second handle can include a U-shape recess for housing a set of tool members. In another embodiment, the first handle can comprise a first axle upon which a first subset of the set of tool members are rotatably mounted. The second handle can include a second axle upon which a second subset of the set of tool members are rotatably mounted. The second handle can include a third axle upon which a further subset of the set of tool members are rotatably mounted.

In another embodiment, the multipurpose tool can further include a carabiner pivotally mounted to the third or other axle. The carabiner can comprise a U-shape box system which is configured to fit within a U-shape housing within the first or second handle, and the box system allows for fitting other subset of tools therewithin in a non-use condition.

The carabiner can be detachably engageable with either the first handle or the second handle. The carabiner can be slidably receivable into at least a part of either the first handle or the second handle.

In another embodiment, the carabiner can include a proximal end and a distal end, wherein the proximal end of the carabiner can be configured for engaging at least a part of either the first handle or the second handle.

In another embodiment, the proximal end of the carabiner can be configured for insertion into at least a part of either the first handle or the second handle to securely connect the carabiner to either the first handle or the second handle, respectively.

In another embodiment, the proximal end of the carabiner and at least a part of either the first handle or the second handle can include releasable mating engagement means. The mating engagement means can include at least one engaging formation on the carabiner that is configured for engagement with at least one complementary engaging aperture of either the first handle or the second handle. The carabiner can be released from the handle by pressing the at least one engaging formation sufficiently to displace the formation from the aperture.

In another embodiment, the distal end of the carabiner can be configured for connection to other pieces of equipment. In this way the multipurpose tool can be carried with a backpack, bumbag or other bag, making it more useful for the outdoor person/animal trainer. A detachable carabiner can be used for:
Carrying keys and accessories including poo bag holders;
Securing a dog to a fixed object-trees, lampposts, benches, D-rings, eyebolts, chain-link fence, without having to take their leash off and tie it;
Clip to belt or backpack for handsfree dog walking;
Single handed operating;
Walking two dogs on one leash by connecting the leashes;
Attaching to handle loop with any waste bags to avoid carrying used waste bag;
Create a carabiner run with rope between two trees.

Embodiments of the carabiner are contemplated to include: D-, Off-set D-, Oval-, and Pear/HMS-shaped carabiners. The locking mechanisms of the carabiner are contemplated to include: double-gate, magnetic, multiple-lever, push-lock, solid gate, twist-and-push-lock, twist-lock, and wire gate locking mechanisms. Further embodiments of manual and auto-locking carabiners and known to a person skilled in the art are also contemplated.

The carabiner system has a number of elements including:
1. It is pivotable around an axle on the handle so as to move from a protruding in use position to a closed small volume closed position;
2. It is shaped as a U-shape to fit within a box U-shape handle so that other subset of tools mounted on the axle can fit at least partially within the U-shape;
3. It is usable in the protruding position to function with the rest of the multipurpose tool such as a carrier mechanism on the user's belt or as a connection to a flying fox for transfer means;
4. It is removable from the multitool in a single action so as to provide a carabiner for use as a separate tool remote from the multitool such as to allow readily removable lockable connection of a dog lead to a fixed structure without need for knots

The multipurpose tool can further include a pair of arms, the pair of arms comprising a first arm mounted upon the first axle to the first handle; and a second arm mounted upon the second axle to the second handle.

The multipurpose tool can further include a fourth axle to which the first arm and second arm are rotatably mounted. Each of the arms can include a blade removably mounted to a portion of the respective arm proximal the fourth (or further) axle, forming a nail cutting station; and a pair of jaws on the end of the arms extending from the nail clipping station; wherein the nail clipping blades and jaws close when the pair of arms are actuated by the handles.

The blades forming the nail clipper can be removed and replaced or sharpened and replaced hence there is no need to discard the entire device.

In another embodiment, the first blade can be mounted to the first arm by a first fastener; and the second blade can be mounted to the second arm by a second fastener.

In another embodiment, each of the first fastener and second fastener can be independently a screw or a bolt.

In another embodiment, the pair of jaws can be an extension of the pair of arms.

In another embodiment, the pair of jaws can include distal ends that abut each other when the pair of arms are actuated.

In another embodiment, the pair of jaws can have an arcuate profile to grasp an object.

Each of the first handle and the second handle can extend from a proximal end to a longitudinally opposed distal end and pivot about the proximal end to move the handles between a closed position and an open position.

Preferably, the nail clipper can include a guard to assist a user in cutting animal nails to a desired length and to prevent the user from overcutting animal nails. Further preferably, the guard is hingedly attached to the fourth axle.

In an embodiment, the multipurpose tool can further include a set of tool members, wherein: a first subset of the set of tool members are carried by and foldable about the first handle; and a second subset of the set of tool members are carried by and foldable about the second handle.

In another embodiment, the first subset and second subset of tool members can include one or more of the group consisting of: a blade; a bottle opener, a can opener; a clicker; a comb configured for use with combing animal hair; a knife, a saw, a pair of scissors; a strap cutter; and a whistle configured for animal training.

The term “clicker” as used herein should be understood to refer to a training tool that produces a loud, crisp, clicking sound, which is useful to provide immediate positive feedback when training an animal.

In another embodiment, the clicker can be slidably receivable into at least a part of the whistle.

In another embodiment, the clicker can be fixably and releasably receivable into at least a part of the whistle.

In another embodiment, the whistle can be removably connectable to the third axle.

In another embodiment, the whistle can be connectable to the third axle by a whistle holder.

In another embodiment, at least one of the first handle and the second handle can include a receptacle formation configured to stow a pair of tweezers and a tick remover.

In another embodiment, the tick remover can be a part of the tweezers.

In another embodiment, the receptacle formation can be a channel formed in the first handle or the second handle.

In another embodiment, the multipurpose tool can further include a biasing mechanism to bias the first handle and the second handle away from each other, when the tool is in an open position.

In another embodiment, the biasing mechanism can be a spring or a resilient member.

In a further related aspect of the present invention there is provided a multipurpose tool adapted to aid training and general care of an animal comprising: a first and second handle wherein the handles include one or more U-shape housings therein for accommodating a range of tool subsets; a first axle in the first handle at one end thereof for pivotally receiving a first subset of tools; a second axle in the second handle at one end thereof for pivotally receiving a second subset of tools; a pair of arms, the each arm of the pair of arms is connected to the first handle and the second handle, via the first axle and the second axle, respectively, wherein the first and second handles rotate relative to the respective arms; a further axle to which the pair of arms are rotatably mounted; wherein the each arm includes a blade removably mounted to a portion of the arm proximal the further axle forming a nail cutting station; and a pair of jaws on the arms extending from the nail clipping station; wherein the pair of jaws close when the pair of arms are actuated by the handles, and the arms are received by the handles in a non-operating condition.

The present invention represents an advance over the prior art devices as it assists in training a dog, i.e., the jaws are configured for grasping an object, such as an object having a scent can be used in detection training. Alternatively, the jaws can also be used to pull or draw out a foreign body from a part of an animal, which is convenient when on an outdoor activity with a dog. The nail clipper blades can also be removed and replaced or sharpened and replaced on the arms so no need to discard the entire device.

The pair of jaws of the multipurpose tool further can be integrally formed with the nail clipper station.

The multipurpose tool can further include a fifth and/or sixth axle located in one or both handles spaced from the first or second axle which is adapted to pivotally receive another subset of tool members for deployment between an in-use condition relative to the handle and a non-use condition within the handle.

The multipurpose tool can yet further include a carabiner that is removably connected to the first handle. The carabiner can comprise a U-shaped box system which includes a proximal end and a distal end. The distal end is configured for connection to other pieces of equipment and can include a latch and in one embodiment, a sliding lock latch. The proximal end is configured for engaging the first handle by inserting the proximal end into an opening at the distal end of the first handle to securely connect the carabiner to the first handle. The proximal end is u-shaped and can receive other tools housed therein.

The proximal end of the carabiner can include at least one engaging formation or at least one projection. Preferably, a pair of engaging formations is disposed on opposite sides of the proximal end of the carabiner. The pair of projections are configured for engagement with a pair of complementary engaging apertures in the first handle. The pair of complementary engaging apertures are located near the opening at the distal end of the first handle. When the carabiner is inserted into the distal end of the first handle, the proximal end of the carabiner distorts so that the projections can slide inside the first handle and engage the apertures. Once the projections have engaged the apertures, the carabiner is securely locked into the first handle. To remove the carabiner, the projections can be depressed towards each other so that the projections disengage the apertures.

The multipurpose tool can further include a tool exchanger. Preferably, the tool exchanger is a depot in one of the first or second handles which is adapted to removably receive a tool. More preferably, the comb component can be interchangeable between a fine comb and a wide comb or a nail file. In relation to a dog multipurpose tool a user could carry different comb sizes and files, making the tool even more versatile.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a side view of a multipurpose tool according to an embodiment in a folded position;

FIG. 2 shows a side view of the multipurpose tool shown in FIG. 1 in a partially unfolded position with tool members extended;

FIG. 3 shows a perspective view of the multipurpose tool shown in FIG. 1 in an unfolded position with some of the tool members extended;

FIG. 4 shows a perspective view of the multipurpose tool shown in FIG. 1 in an unfolded position;

FIG. 5 shows a perspective view of according to another embodiment in a partially unfolded position;

FIG. 6 shows a side view of the multipurpose tool shown in FIG. 5 in a partially unfolded position;

FIG. 7 shows a side view of the multipurpose tool shown in FIG. 5 in a folded position;

FIG. 8 shows a side view of the multipurpose tool shown in FIG. 5 in a partially unfolded position;

FIG. 9 shows a side view of the multipurpose tool shown in FIG. 5 with component parts;

FIG. 10 shows a perspective view of the multipurpose tool of FIG. 5 with a clicker partially withdrawn and alongside;

FIG. 11 shows perspective views of the multipurpose tool of FIG. 5 with a carabiner in engaged, removed, and alongside positions;

FIG. 12 shows a perspective view of the multipurpose tool of FIG. 5 with a strap cutter in a deployed for use position and alongside;

FIG. 13 shows a perspective view of the multipurpose tool of FIG. 5 with a can opener/bottle opener in a deployed for use position;

FIG. 14 shows a perspective view of the multipurpose tool of FIG. 5 with a tweezer and tick remover in engaged, deployed for use, and alongside positions;

FIG. 15 shows a perspective view of the multipurpose tool of FIG. 5 with scissors in a deployed for use position;

FIG. 16 shows a perspective view of the multipurpose tool of FIG. 5 with a knife in a deployed for use position;

FIG. 17 shows a perspective view of the multipurpose tool of FIG. 5 with a comb in a deployed for use position and alongside; and

FIG. 18 shows a perspective view of the multipurpose tool of FIG. 5 with a pair of jaws and nail clipper in an open position and a detailed view of the pair of jaws and nail clipper.

### DESCRIPTION OF EMBODIMENTS

It should be noted in the following description that like or the same reference numerals in different embodiments denote the same or similar features.

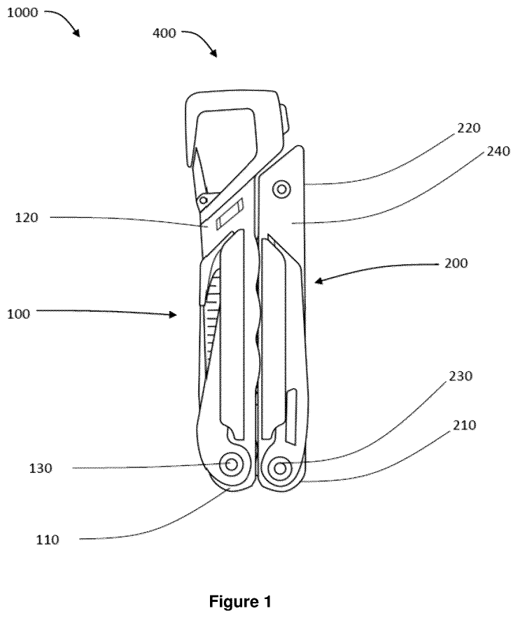

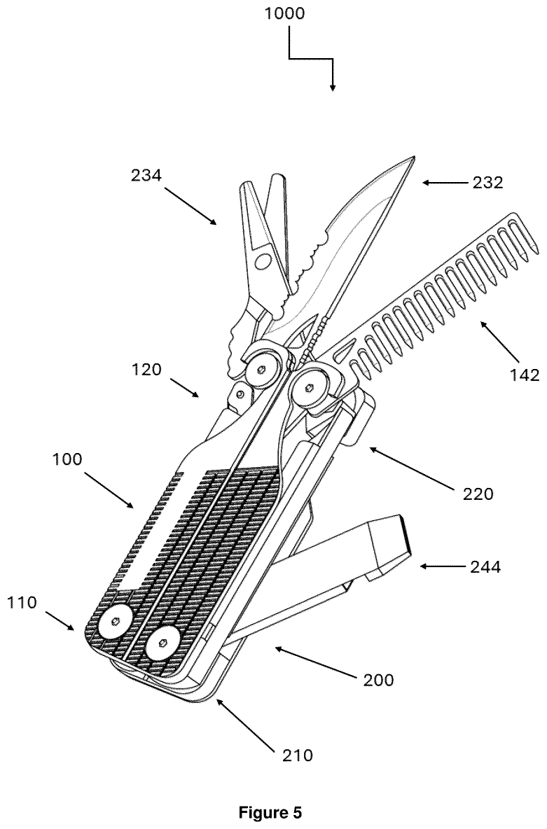

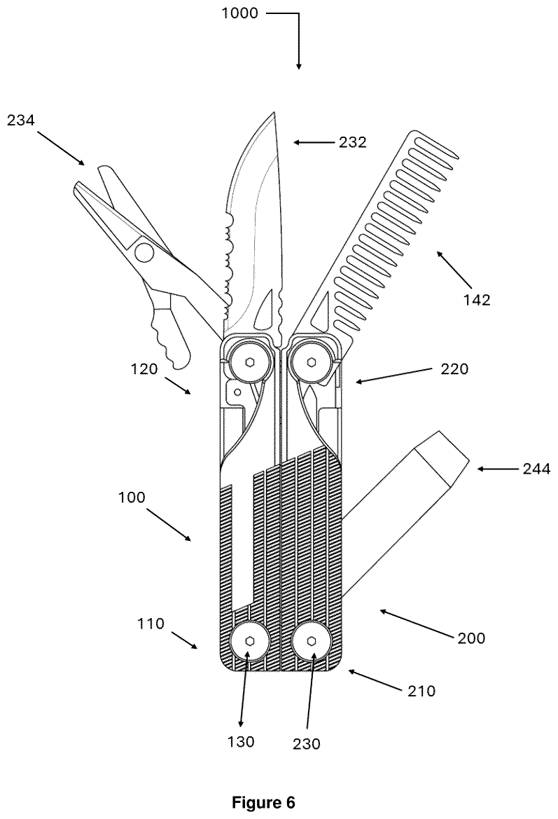

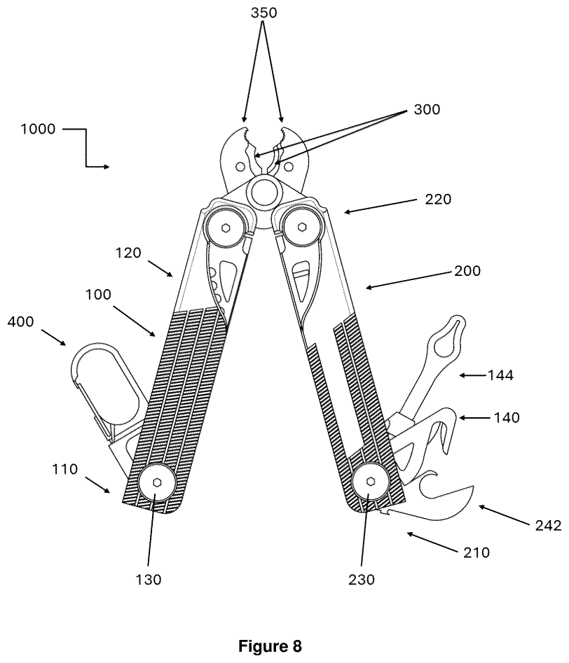

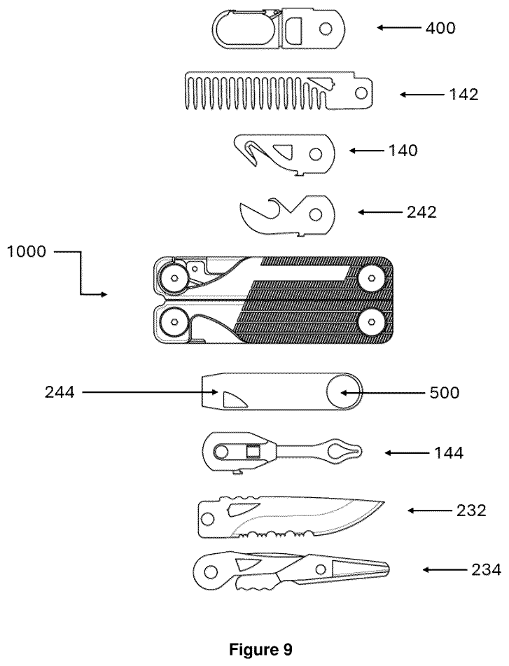

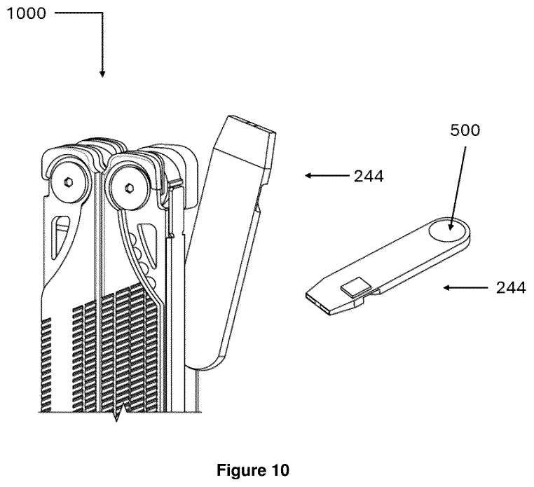

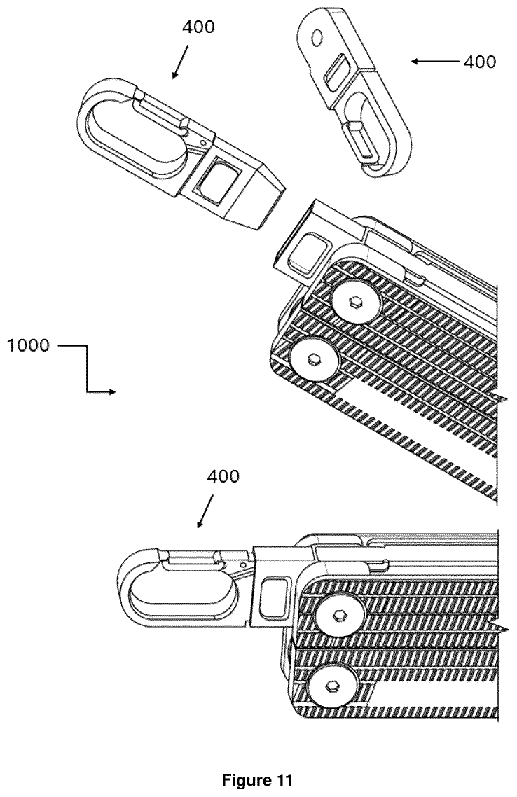

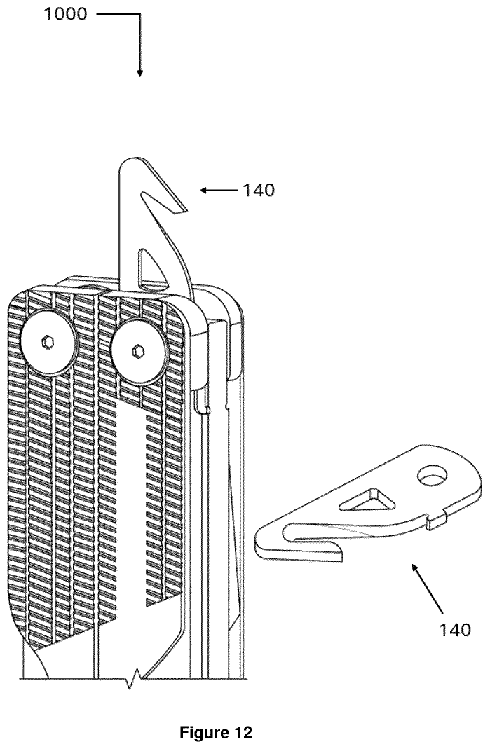

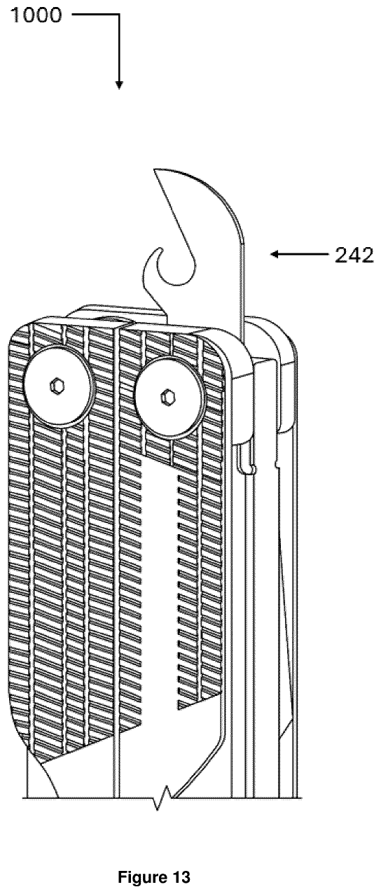

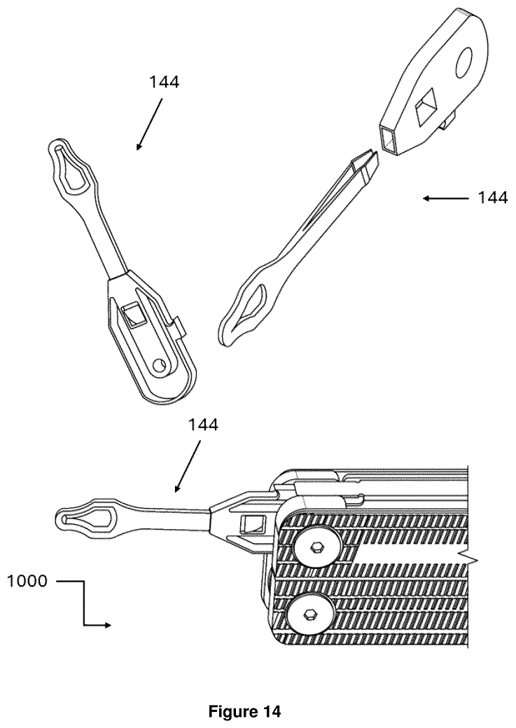

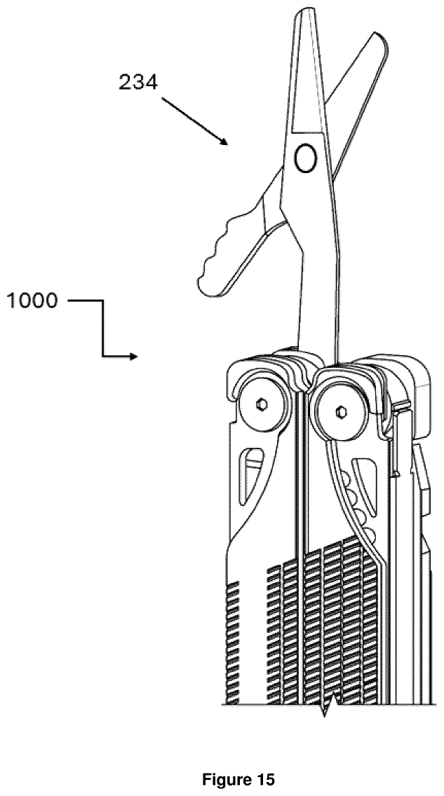

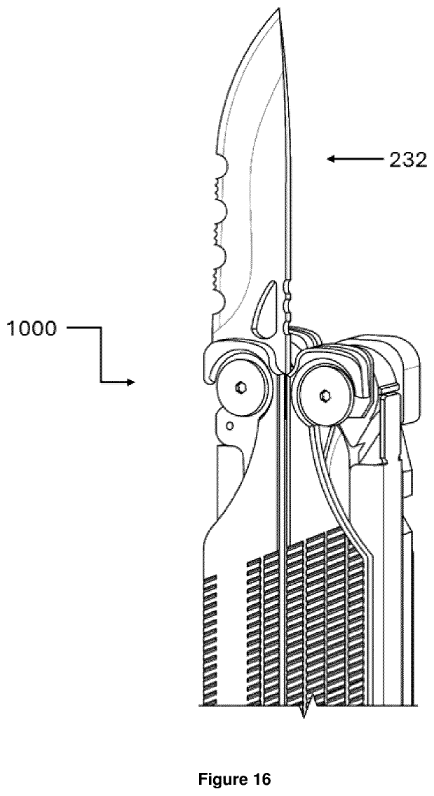

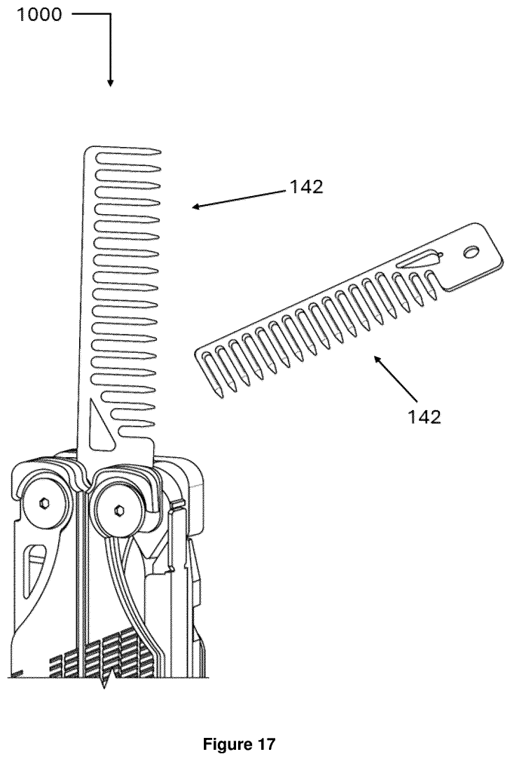

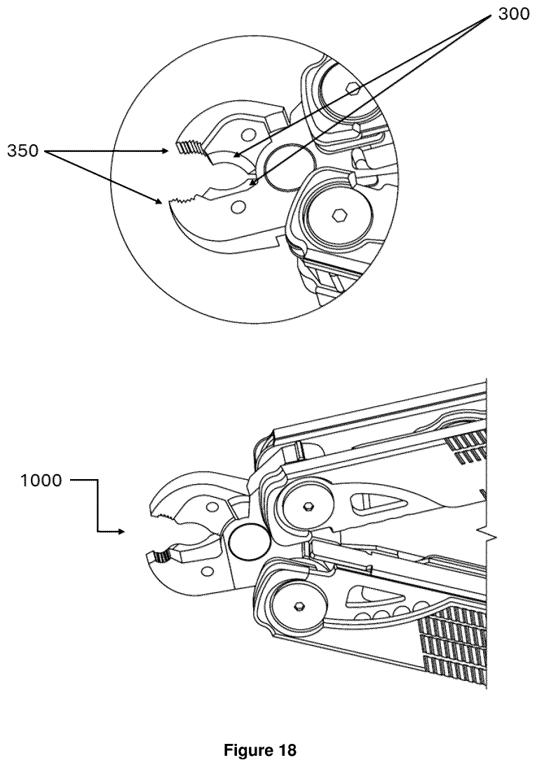

FIGS. 1 to 18 show embodiments of a multipurpose tool according to an aspect of the invention that is generally indicated by the numeral 1000.

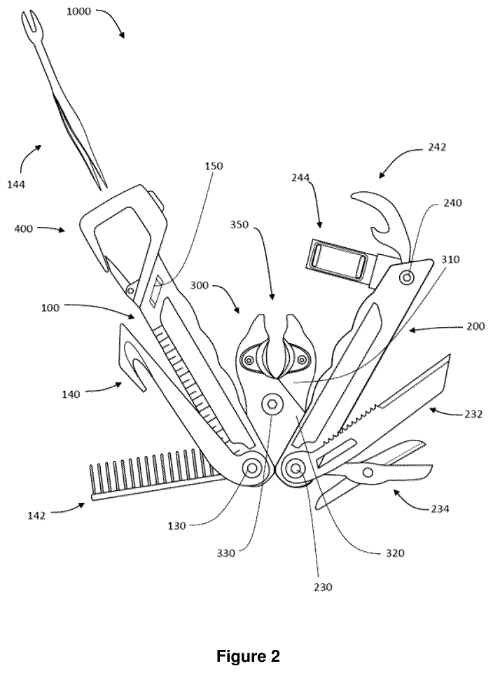

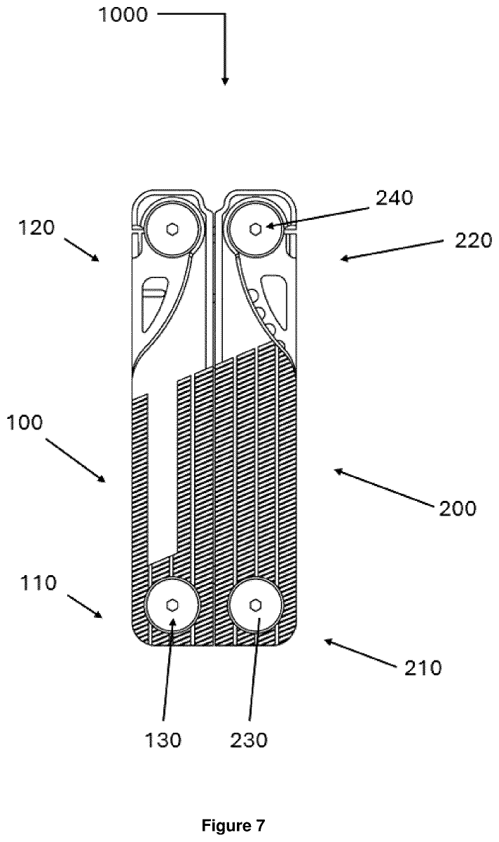

The multipurpose tool 1000 is configured for use with animals, such as dogs. The tool 1000 includes a first handle 100 and a second handle 200. The first handle 100 and the second handle 200 are each configured for relative movement between a closed position as shown, for example, in FIGS. 1 and 7, and open positions as shown, for example, in FIGS. 2-6 and 8. The first handle 100 and the second handle 200 can be made from a non-slip material or feature a non-slip outer surface to provide a user with more grip.

The multipurpose tool 1000 also includes a nail clipper 300 for cutting nails of an animal, such as a dog, more clearly shown in FIGS. 2-4, 8 , and 18. The multipurpose tool 1000 further includes a pair of jaws 350 integrally formed with the nail clipper 300. The pair of jaws is configured for grasping an object, such as an object having a scent and can be used in detection training. The pair of jaws may also be used to pull- or draw-out a foreign body from a part of an animal or a user. The term “foreign body” as used herein should be understood to mean, for example, a body part of an animal, a piece of glass, a piece of a plant, tree, or shrub, a piece of wire, a spike, and the like.

FIGS. 2-6 and 8 show the tool 1000 with the first handle 100 and the second handle 200 in a partially open position or a partially closed position. A plurality or a set of tool members are shown partially extended. A first subset of the set of tool members are carried by and foldable about the first handle 100. A second subset of the set of tool members are carried by and foldable about the second handle 200.

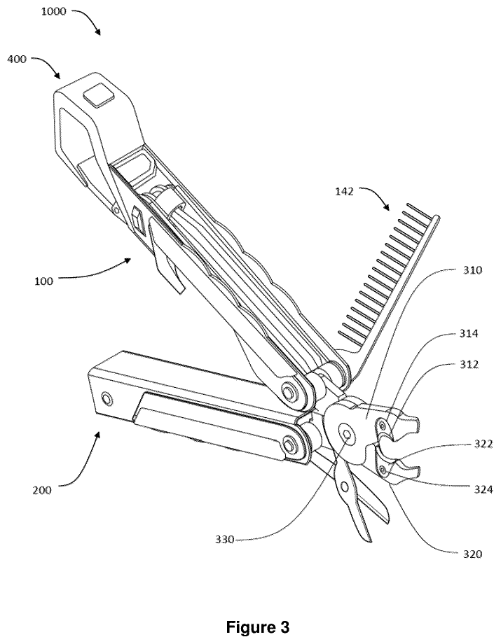

The first handle 100 and second handle 200 is recessed in a U-shape configuration for housing a subset of tool members. The first handle and the second handle are conjoined at a mutual axle 330 and adapted to move about the mutual axle between a closed position (FIG. 1) and an actuating or open position (FIGS. 2 and 3). A pair of arms 310, 320 are connected to the first and second handle and rotatably mounted to the mutual axle 330 wherein the first and second handle are adapted to pivot relative to the arms. There is shown a removable nail clipper 312, 322 on the arms configured for cutting an animal nail and a pair of jaws 350 integrally formed with the nail clipper. As shown, the handles are configured to receive the pair of jaws in a closed condition within the U-shape recesses, and rotating the handles relative to the arms to the actuating position allows closing of the jaws for grasping an object.

The first handle 100 extends from a proximal end 110 to a longitudinally opposed distal end 120. The second handle 200 extends from a proximal end 210 to a longitudinally opposed distal end 220. Each of the first handle 100 and the second handle 200 pivot about the respective proximal ends 110, 210 to move between the closed position and the open position. The first handle 100 includes a first axle 130 at the proximal end upon which the first subset of the set of tool members are rotatably mounted. The second handle 200 comprises a second axle 230 at the proximal end upon which a portion of the second subset of the set of tool members are rotatably mounted. A third axle 240 is also provided at the distal end upon which another portion of the second subset of the set of tool members are rotatably mounted.

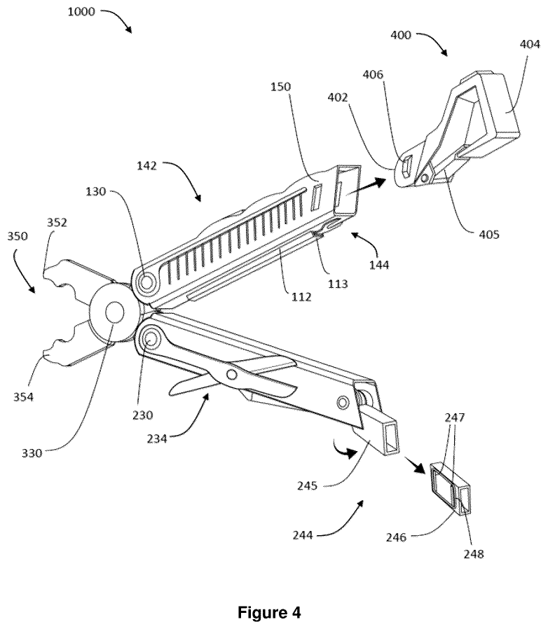

The multipurpose tool 1000 further includes a pair of arms 310, 320 that form part of the nail clipper 300. Each arm 310, 320 of the pair of arms is connected to the first handle 100 and the second handle 200, via the first axle 130 and the second axle 230, respectively. The axle 130 serves to allow the first handle 100 to move or rotate about the proximal end 110 relative to the arm 310. The second axle 230 serves to allow the second handle 200 to move or rotate about the proximal end 230 relative to the arm 320. In this way, the first handle 100 can rotate about the proximal end 110 and lock into a position such that the first handle 100 and the arm 310 are relatively straight or longitudinally in line with each other. Similarly, the second handle 200 can rotate about the proximal end 210 and lock into a position such that the second handle 200 and the arm 320 relatively straight or longitudinally in line with each other. A notch and a cam (not shown) located on the first axle 130 and the second axle 230 allow the first handle 100 and the second handle 200 to lock in the open position shown, for example, in FIGS. 3 and 4.

The arm 310 of the nail clipper 300 includes a first blade 312 that is mounted to the arm 310 via a first fastener 314. Similarly, the arm 320 includes a second blade 322 that is mounted to the arm 320 via second fastener 324.

The multipurpose tool 1000 further includes a fourth axle 330 to which the pair of arms 310, 320 are rotatably mounted such that in use, the first blade 312 and the second blade 322 are movable toward and away from each other. This is possible when the first handle 100 and the second handle 200 are locked in place via the notch and cam. It is envisaged that the first blade 312 and the second blade 322 can be removed from the respective pair of arms 310, 320 for replacement or sharpening by undoing fastener 314, 324. The fastener 314, 324 may be a screw or a bolt. Replaceable blades 312, 322 mean that the user does not need to purchase a new tool 1000 when the blades become dull.

As shown, for example, in FIGS. 2-4, 8 , and 18, the pair of jaws 350 extend from the nail clippers 300 or the pair of arms 310, 320. The pair of jaws 350 each include a distal end 352, 354 which abut each other when the pair of arms 310, 320 are actuated. The pair of jaws 350 have an arcuate profile which serves to grasp an object. For detection training, the object could be anything such as, for example, cotton buds, tubes, or biological samples. Using the jaws 350 to grasp an object having a scent eliminates the need to use other items to move an object with a training odour on it, as the jaws 350 can be cleaned with a detection equipment cleaning agent to rid the jaws 350 of unwanted scents. In detection training, bare hands are not used as the object to be detected is contaminated with the scent of one's hands. Gloves can be used in detection training; however, the gloves must be disposed after every use, meaning that gloves are very wasteful. The jaws 350 or the tweezers (144 discussed below) are used in detection training as they can be easily cleaned after each use. The jaws 350 or tweezers 144 can also be used to pick up items in the field (a biological sample for instance) or to remove a foreign body lodged in the body of an animal or a user, for example, as mentioned above.

The set of tool members rotatably mounted to the first axle 130 of the first handle 100 include a strap cutter 140 and a comb 142. The strap cutter is a safety element used to free an animal from a collar, harness or seatbelt in an emergency. It can also open packages without damaging contents. The comb 142 is configured for use with combing animal hair, specifically dog hair. The set of tool members rotatably mounted to the second axle 230 of the second handle 200 include a blade or a saw 232 (or a combination blade that is both straight and serrated as shown) and a pair of scissors 234. The set of tool members rotatably mounted to the third axle 240 include a can opener/bottle opener 242 and a whistle 244 that is configured for animal training.

Best seen in FIG. 4, the whistle 244 includes a whistle holder 245 and a whistle body 246. The whistle 244 is rotatable about the third axle 240 between an undeployed position and a deployed position. FIG. 4 shows the whistle 244 in the deployed position where the whistle body 246 is removed from the whistle holder 245. The whistle body 246 has a pair of projections 247 and a ligature 248 connected to the whistle body 246. The ligature 248 can be wrapped around the pair of projections 247 such that the ligature 248 can be neatly stowed when the whistle 244 is not in use. It is envisaged that during use, such as when training an animal with the whistle body 246, the whistle body 246 can be removed from the whistle holder 245 whilst the tool 1000 can be used for other tasks. The ligature 248 can be used to secure the whistle body 246 to a user's neck, hand, wrist, or other body part.

The whistle body 246 may have one or more channels (not shown) to that allow high frequency sound to be emitted from the whistle body 246 when a user blows through an end of the whistle body 246 with their mouth. It is envisaged that the channels are configured to emit sound having a frequency of about 23-54 kHz during use for the purposes of training an animal such as a dog.

Best seen in FIGS. 2, 4, 9, and 14 is a pair of tweezers and a tick remover 144 combined into a single tool member. The tweezer/tick remover 144 is holdable by the tool in a channel 112 that projects from the first handle 100. The channel 112 has an opening 113 where the tweezer/tick remover 144 is inserted and held by the channel 112 so that the tweezer/tick remover 144 can be safely stowed. In an alternative embodiment, the channel 112 with opening 113 may be located on the second handle 200.

The multipurpose tool 1000 further includes a carabiner 400 that is connected to the first handle 100. The carabiner 400 includes a proximal end 402 and a distal end 404. The distal end 404 is configured for connection to other pieces of equipment and can include a latch and in one embodiment, a sliding lock latch 405. The proximal end 402 is configured for engaging the first handle 100 by inserting the proximal end 402 into an opening at the distal end 120 of the first handle 100 to securely connect the carabiner 400 to the first handle 100. The proximal end of the carabiner as shown in FIGS. 3 and 4 includes a u-shape frame which is received within the first handle such that a subset of tools can be received thereby within the first handle.

The carabiner 400 is detachable from the first handle 100 as shown, for example, in FIG. 4. The proximal end 402 of the carabiner 400 includes at least one engaging formation or at least one projection 406. In the embodiment shown, there is a pair of engaging formations or a pair of projections 406 disposed on opposite sides of the proximal end 402 of the carabiner 400. The pair of projections 406 are configured for engagement with a pair of complementary engaging apertures 150 in the first handle. The pair of complementary engaging apertures 150 at located near the opening at the distal end 120 of the first handle 100. When the carabiner 400 is inserted into the distal end 120 of the first handle 100, the proximal end 402 of the carabiner 400 bends inwardly so that the projections 406 can slide inside the first handle 100 and engage the apertures 150. Once the projections 406 have engaged the apertures 150, the carabiner 400 is securely locked into the first handle 100. To remove the carabiner 400, the user pushes or depresses the projections 406 in toward each other so that the projections disengage the apertures 150. Doing so will allow the user to slide the carabiner 400 out of the first handle 100.

It is particularly advantageous to be able to remove the carabiner 400 from the first handle 100 of the multipurpose tool 1000. The carabiner 400 can be used when required for a task whilst the remainder of the multipurpose tool 1000 can be pocketed or used for performing other tasks simultaneously. For example, a lead of a dog can be secured to an object using the carabiner 400 whilst the remainder of the multipurpose tool 1000 can be used for a different purpose.

Not shown in the figures is a biasing mechanism to bias the first handle 100 and the second handle 200 away from each other, when the multipurpose tool 1000 is in an open position. The biasing mechanism allows the user to actuate the first handle 100 and the second handle 200 more easily, as the first handle 100 and the second handle 200 are biased toward the open position. The biasing mechanism may be a resilient member, spring, or the like.

Also not shown in the figures is a guard to assist a user in cutting animal nails to a desired length and to prevent the user from overcutting animal nails. The guard (not shown) can be connected to the fourth axle 330 and may be pivotable about the axle 330 or removable. The guard serves to prevent the user from inserting too much of an animal's nail between the blades 312, 322.

In one embodiment, one of the first handle 100 and the second handle 200, may have a clicker (500) integrated therein, so that the user can use the clicker for positive reinforcement training.

### Benefits

Improved dog training-for example use of clicker and whistle for general obedience training, and jaws used for laying scent targets for scent detection training, and removal of foreign matter;
Improved nail clipper which can be removed hence no need to discard device;
Includes a carabiner which is removable from the multitool in a single action to provide use as a separate tool remote from the multipurpose tool such as to allow readily removable lockable connection of a dog lead to a fixed structure without need for knots;
The carabiner is usable in a protruding position connected to the handle to function with the rest of the multipurpose tool such as a carrier mechanism on the user's belt or as a connection to a flying fox for transfer means;
Can be used to operate multiple animals single handed.

### INTERPRETATION

### Embodiments

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Description of Embodiments are hereby expressly incorporated into this Description of Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures, and techniques have not been shown in detail in order not to obscure an understanding of this description.

### Terminology

In describing the preferred embodiment of the invention illustrated in the drawings, specific terminology will be resorted to for the sake of clarity. The invention is, however, not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to animal owners, animal trainers and animal training industries, domestic animal obedience training.

1-39. (canceled)

40. A multipurpose tool configured for use with animals, the multipurpose tool comprising:
a first handle and a second handle, the first handle comprising a first axle upon which a first subset of tool members is rotatably mounted;
the second handle including:
a second axle upon which a portion of a second subset of tool members are rotatably mounted; and
a third axle upon which another portion of the second subset of tool members are rotatably mounted;
a pair of arms, each arm of the pair of arms is connected to the first handle and the second handle, via the first axle and the second axle, respectively, wherein the first and second handles rotate relative to the respective arms; and
a fourth axle to which the pair of arms are rotatably mounted;
wherein each arm includes a blade removably mounted to a portion of the arm proximal the fourth axle forming a nail cutting station and a pair of jaws on the arms extending from the nail clipping station; and
wherein the pair of jaws close when the pair of arms are actuated by the handles, and the arms are received by the handles in a non-operating or closed condition.

41. The multipurpose tool of claim 40, further comprising a carabiner, wherein the carabiner is detachably engageable with either the first handle or the second handle.

42. The multipurpose tool of claim 41, wherein the carabiner is slidably receivable into at least a part of either the first handle or the second handle.

43. The multipurpose tool of claim 41, wherein the carabiner comprises a proximal end and a distal end, wherein the distal end is configured for connection to other pieces of equipment and includes a latch, and the proximal end is configured for engaging the first handle by inserting the proximal end into an opening at the distal end of the first handle to securely connect the carabiner to the first handle.

44. The multipurpose tool of claim 43, wherein the proximal end is u-shaped and adapted to receive other subset of tools housed therein.

45. The multipurpose tool of claim 43, wherein the proximal end of the carabiner and at least a part of either the first handle or the second handle includes releasable mating engagement means comprising:
at least one engaging protrusion formation on the carabiner; and
at least one complementary engaging aperture of either the first handle or the second handle;
wherein the aperture is configured to receive the protrusion in an engaged condition.

46. The multipurpose tool according to claim 45, wherein the first handle comprises a first axle upon which the first subset of the set of tool members are rotatably mounted and the second handle includes:
a second axle upon which a portion of the second subset of the set of tool members are rotatably mounted; and
a third axle upon which another portion of the second subset of the set of tool members are rotatably mounted.

47. The multipurpose tool according to claim 46, further comprising a pair of arms, the pair of arms comprising:
a first arm mounted upon the first axle to the first handle; and
a second arm mounted upon the second axle to the second handle,
wherein the nail clipper includes a first blade and a second blade,
the first blade is mounted to the first arm by a first fastener; and
the second blade is mounted to the second arm by a second fastener,
wherein the first blade and the second blade are removable from the pair of arms for replacement or sharpening.

48. The multipurpose tool according to claim 47, wherein the pair of jaws have an arcuate profile to grasp an object.

49. The A multipurpose tool according to claim 47, wherein the first subset and second subset of tool members includes one or more of the group consisting of: a blade; a bottle opener; a can opener; a clicker; a comb configured for use with combing animal hair; a knife, a saw, a pair of scissors; a strap cutter; and a whistle configured for animal training.

50. The multipurpose tool according to claim 49, wherein the clicker is fixably and releasably receivable into at least a part of the whistle.

51. The multipurpose tool according to claim 46, wherein at least one of the first handle and the second handle includes a receptacle formation formed in the first handle or the second handle configured to stow a pair of tweezers and a tick remover.

52. The multipurpose tool according to claim 51, wherein the tick remover is a part of the tweezers.

53. The multipurpose tool according to claim 52, further including a carabiner wherein the carabiner is detachably engageable with either the first handle or the second handle.

54. The multipurpose tool according to claim 52, wherein the carabiner is slidably receivable into at least a part of either the first handle or the second handle.

55. The multipurpose tool according to claim 54, wherein the carabiner includes a proximal end and a distal end and wherein the proximal end of the carabiner is configured for engaging at least a part of either the first handle or the second handle wherein the proximal end of the carabiner is configured for insertion into at least a part of either the first handle or the second handle to securely connect the carabiner to either the first handle or the second handle, respectively.

56. The multipurpose tool according to claim 54, wherein the proximal end of the carabiner includes at least one engaging formation that is configured for engagement with at least one receiving aperture of either the first handle or the second handle.

57. The multipurpose tool according to claim 56, wherein the distal end of the carabiner is configured for connection to other pieces of equipment.

58. The multipurpose tool according to claim 46, further comprising a biasing mechanism to bias the first handle and the second handle away from each other, when the tool is in an open position wherein the biasing mechanism is a spring or a resilient member.

59. A multipurpose tool adapted to aid training and general care of an animal comprising:
a first and second handle wherein the handles include one or more U-shape housings therein for accommodating a range of tool subsets;
a first axle in the first handle at one end thereof for pivotally receiving a first subset of tools;
a second axle in the second handle at one end thereof for pivotally receiving a second subset of tools;
a carabiner detachably engageable with either the first handle or the second handle, wherein the carabiner is slidably receivable into at least a part of either the first handle or the second handle and adapted to receive a subset of tools;
a pair of arms, each arm of the pair of arms is connected to the first handle and the second handle, via the first axle and the second axle, respectively, wherein the first and second handles rotate relative to the respective arms;
a further axle to which the pair of arms are rotatably mounted; wherein the each arm includes a blade removably mounted to a portion of the arm proximal the further axle forming a nail cutting station; and
a pair of jaws on the arms extending from the nail clipping station;
wherein the pair of jaws close when the pair of arms are actuated by the handles, and the arms are received by the handles in a non-operating condition.
